(19) United States
(12) Patent Application Publication
(10) Pub. No.: US 2017/0155731 A1
(43) Pub. Date: Jun. 1, 2017

(54) METHOD AND DEVICE FOR INCREASING CACHE HIT RATIO

(71) Applicants: Le Holdings (Beijing) Co., Ltd., Beijing (CN); LETV SPORTS CULTURE DEVELOP(BEIJING) CO., LTD., Beijing (CN)

(72) Inventors: Chuanxiao PANG, Beijing (CN); Ranyang Wang, Beijing (CN)

(21) Appl. No.: 15/246,508

(22) Filed: Aug. 24, 2016

Related U.S. Application Data
(63) Continuation of application No. PCT/CN2016/089480, filed on Jul. 8, 2016.

(30) Foreign Application Priority Data
Dec. 1, 2015 (CN) 201510863189.1

(51) Int. Cl. H04L 29/08; H04L 12/26

(52) U.S. Cl. CPC H04L 67/2842; H04L 43/08; H04L 67/02

(57) ABSTRACT

Disclosed are a method and a device for increasing cache hit ratio. The method includes: obtaining first data request information, and determining whether there is a format parameter in the first data request information, wherein the first data request information is data request information originally obtained by the web server; if determining that there is the format parameter in the first data request information, deleting the format parameter; obtaining a first data response packet corresponding to the first data request information, and determining whether the first data response packet includes format data corresponding to the format parameter; if determining that the first data response packet includes the format data corresponding to the format parameter, deleting the format data; and storing the first data request information after deletion of the format parameter and the first data response packet after deletion of the format data in a cache server.

### CROSS REFERENCE TO RELATED APPLICATIONS

This application is a continuation of International Application No. PCT/CN2016/089480, filed on Jul. 8, 2016, which is based upon and claims priority to Chinese Patent Application No. 201510863189.1, filed on Dec. 1, 2015, the entire contents of which are incorporated herein by reference.

### TECHNICAL FIELD

The present disclosure relates to internet technologies, and more particularly, to a method and a device for increasing cache hit ratio.

### BACKGROUND

With proliferation of Internet, people's demands for access efficiency of web servers have increased. At present, previously accessed data are added into a cache server. Reading data from the cache server is faster than reading the same data from a service server. When a user sends data request information to a web server, the web server firstly checks whether there is corresponding data in the cache server according to the data request information; if there is, the cache server sends the data corresponding to the data request information to the user. In this way, access efficiency of the web server is increased.

The procedure for a web server to add previously requested data into a cache server can be as follows. According to a Uniform Resource Locator (URL) in user data request information, the web server creates a key; after a service server sends data to the user, the web server obtains a data (i.e., the value) corresponding to the key, and adds a key-value pair (<key, value>) into the cache server.

There is a problem when adding the key-value pair into the cache server using the above method. When creating the key, the web server takes the whole or a part of the URL as the cache key. If the URL in the data request information sent by the user is not consistent with the cache key in the cache server, the value stored in the cache server cannot be red. Thus, the cache hit ratio is reduced. Meanwhile, when storing the value, the web server directly adds the value returned by the service server into the cache server. Since the same data can have different types, there is a high chance that the data requested by the user is different from the data (i.e., the value) stored in the cache server. Thus, the cache hit ratio is further lowered.

### SUMMARY

The present disclosure provides a method and a device for increasing cache hit ratio so as to increasing the cache hit ratio in a cache server.

In a first aspect, embodiments of the present disclosure provide a method for increasing cache hit ratio, implemented by a server, including:
obtaining first data request information, and determining whether there is a format parameter in the first data request information, wherein the first data request information is data request information originally obtained by the server;
if determining that there is the format parameter in the first data request information, deleting the format parameter;
obtaining a first data response packet corresponding to the first data request information, and determining whether the first data response packet includes format data corresponding to the format parameter, wherein the format data is configured to describe a format corresponding to data requested by the first data request information;
if determining that the first data response packet includes the format data corresponding to the format parameter, deleting the format data; and
storing the first data request information after deletion of the format parameter and the first data response packet after deletion of the format data in a cache server, wherein the first data request information after deletion of the format parameter corresponds to the first data response packet after deletion of the format data one to one.

In a second aspect, embodiments of the present disclosure provide an electronic device, including:
at least one processor; and
a memory communicably connected with the at least one processor for storing instructions executable by the at least one processor, wherein execution of the instructions by the at least one processor causes the at least one processor to perform any methods for increasing cache hit ratio mentioned by embodiments of the present disclosure.

In a third aspect, embodiments of the present disclosure provide a non-transitory computer-readable storage medium storing executable instructions that, when executed by an electronic device, cause the electronic device to perform any methods for increasing cache hit ratio mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for increasing cache hit ratio in accordance with some embodiments.

FIG. 2 is a flow chart of a method for a web server to respond to data request information sent from a client in accordance with some embodiments.

FIG. 3 is a block diagram of a device for increasing cache hit ratio in accordance with some embodiments.

FIG. 4 is a block diagram of another device for increasing cache hit ratio in accordance with some embodiments.

FIG. 5 is a block diagram showing a structure of a web server in accordance with some embodiments.

FIG. 6 is a block diagram showing a structure of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

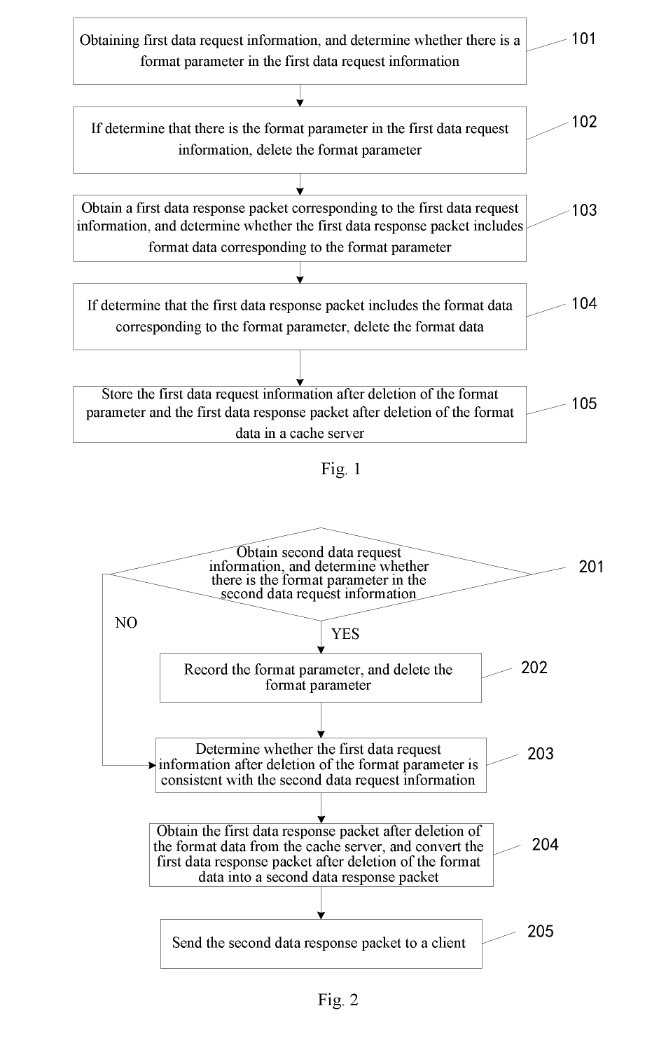

An embodiment of the present disclosure provides a method for increasing cache hit ratio, which is applied in a server, for example, a web server. As shown in FIG. 1, the method can include the following step.

In 101, a server obtains first data request information, and determines whether there is a format parameter in the first data request information.

The web server receives and obtains first data request information sent from a client based on Http-Hypertext Transfer Protocol (HTTP). A Uniform Resource Locator (URL) is included in the first data request information. The web server obtains data corresponding to the first data request information from a service server or a cache server according to the URL.

In an embodiment of the present disclosure, the web server receives the first data request information based on a service processing interface of the web sever itself. The service processing interface responds to the first data request information according to necessary parameters recorded in a configuration file for responding to the data request information. After obtaining the first data request information, the web server determines whether there is a format parameter in the first data request information. The format parameter is a unnecessary parameter for the web server to respond to the first data request information. The format parameter generally includes a JSONP (JSON with Padding) format parameter used by the client when the web server sends a first data response packet to the client. Specific details about the JSONP format can be found in conventional technologies, and detailed description are not elaborated herein.

It should be noted that the first data request information is data request information originally obtained by the web server. As an implementation in embodiments of the present disclosure, the original obtaining of the first data request information by the web server should be interpreted in a conventional sense, i.e., the web server has never received the first data request information before. As another implementation in embodiments of the present disclosure, the web server may have obtained the first data request information, but the valid time for the web server to store the first data request information has become stale, and then the obtaining of the first data request information by the web server at this time can be deemed as the first obtaining.

In 102, if determining that there is the format parameter in the first data request information, the server deletes the format parameter.

If determining that there is the format parameter in the first data request information, the web server deletes the format parameter; if determining that the format parameter does not exist in the first data request information, the web server directly performs step 103.

In 103, the server obtains a first data response packet corresponding to the first data request information, and determines whether the first data response packet includes format data corresponding to the format parameter.

The web server sends the first data request information to a service server which generates corresponding request results according the data request information from the client. When the service server sends a first data response packet corresponding to the first data request information to the client, the web server obtains the first data response packet, and determines whether the first data response packet includes format data corresponding to the format parameter. If determining that the first data response packet includes format data corresponding to the format parameter, the web server performs step 104; if determining that the first data response packet does not include format data corresponding to the format parameter, the web server stores the first data request information after deletion of the format parameter and the first data response packet in a cache server. In embodiments of the present disclosure, the format data is configured to describe a format corresponding to data requested by the first data request information.

In 104, if determining that the first data response packet includes the format data corresponding to the format parameter, the server deletes the format data.

In 105, the server stores the first data request information after deletion of the format parameter and the first data response packet after deletion of the format data in the cache server.

The web server stores the first data request information after deletion of the format parameter and the first data response packet after deletion of the format data in the cache server, with the first data request information after deletion of the format parameter as the key and the first data response packet after deletion of the format data as the value. The key corresponds to the value, and the key and value are firstly stored in the cache server.

The web server stores pairs of key and value in the cache server, and records the address of the cache server which stores the pairs of key and value. When the client sends request information including the key, the web server obtains a corresponding value according to the address of the cache server recorded by the web server, and sends the value to the client.

In the methods for increasing cache hit ratio provided by embodiments of the present disclosure, firstly, a web server obtains first data request information, and determines whether there is a format parameter in the first data request information; the first data request information is data request information originally obtained by the web server; if there is the format parameter in the first data request information, the web server deletes the format parameter; then, the web server obtains a first data response packet corresponding to the first data request information, and determines whether the first data response packet includes format data corresponding to the format parameter; if the first data response packet includes format data corresponding to the format parameter, the web server deletes the format data from the first data response packet; finally, the web server stores the first data request information after deletion of the format parameter and the first data response packet after deletion of the format data in a cache server. As compared with prior technologies, the web server in embodiments of the present disclosure deletes the format parameter from the received data request information, and this can increase the possibility that the data request information matches a key in the cache server. Further, the web server deletes the format data from the obtained first data response packet to make the same data (value) have the same type. Thus, the cache hit ratio is increased, and latency for responding to the data requests from clients is shortened.

Further, to extend and give more details about the above embodiments, the determining of whether there is the format parameter in the first data request information in step 101 can be implemented as follows: the web server parses the obtained first data request information, obtains a URL included in the first data request information, and determines whether there is the format parameter in the URL. As an example, if it is assumed that the URL included in the first data request information is:

http://api.lesports.com/sis-web/app/match/getMatchStatusByMatchIds?version=2.0&ids=1070, then the web server can determine that the URL includes a format parameter version=2.0. The web server can delete the format parameter version=2.0, and store the URL after deletion of the format parameter (http://api.lesports.com/sis-web/app/match/getMatchStatusByMatchIds?ids=1070) and corresponding data response packet in the cache server, with the URL after deletion of the format parameter and the corresponding data response packet as the key and value, respectively.

Further, based on the method described in connection with FIG. 1, after storing the first data request information after deletion of the format parameter and the first data response packet after deletion of the format data in the cache server, i.e., after storing the key-value pair in the cache server, the web server can respond to data request information sent from the client based on the key and value stored in the cache server. The web server can use, but not limited to, the following method to respond to data request information. As shown in FIG. 2, the method can include the following steps.

In 201, the web server obtains second data request information, and determines whether there is the format parameter in the second data request information.

If it is determined that there is the format parameter in the second data request information, step 202 is performed; if it is determined that there is not the format parameter in the second data request information, step 203 is performed.

The web server can obtain second data request information, which can be consistent with the key stored in the cache server or not. Embodiments of the present disclosure do not impose specific limitations on the contents of the second data request information.

As an example, if it is assumed that the second data request information includes a URL: http://api.lesports.com/sis-web/app/match/getMatchStatusByMatchIds?ids=1070&callback=abc, it can be determined that the format parameter in the second data request information includes callback=abc. If the second data request information includes a URL: http://api.lesports.com/sis-web/app/match/getMatchStatusByMatchIds?ids=1070, it can be determined that there is not the format parameter in the second data request information. It should be noted that the web server can determine whether there is the format parameter in the second data request information according to the above description, and repeated description is omitted here.

In 202, the web server records the format parameter, and then deletes the format parameter.

When determining that there is the format parameter in the second data request information, the web server records the format parameter. By doing this, when the web server, based on the second data request information after deletion of the format parameter (i.e., the key in the cache server), obtains corresponding data (i.e., value), the web server dynamically adds the format data corresponding to the format parameter for the data (i.e., value). This can increase the access efficiency of the web server and guarantee the accuracy in data obtaining by the client.

Referring to the above example again, if the second data request information includes a URL:

http://api.lesports.com/sis-web/app/match/getMatchStatusByMatchIds?ids=1070&callback=abc, the URL after deletion of the format parameter can be:
http://api.lesports.com/sis-web/app/match/getMatchStatusByMatchIds?ids=1070. The format parameter recorded by the web server can include: callback=abc.

In 203, the web server determines whether the first data request information after deletion of the format parameter is consistent with the second data request information.

When determining that there is not the format parameter in the second data request information, the web server determines whether the second data request information is consistent with the first data request information after deletion of the format parameter, i.e., the key in the cache server. Or, the web server determines whether the first data request information after deletion of the format parameter (i.e., the key in the cache server) is consistent with the second data request information after deletion of the format parameter. If the first data request information after deletion of the format parameter is consistent with the second data request information after deletion of the format parameter, step 204 is performed; if not, it is indicated that the cache server does not store data corresponding to the second data request information, and the web server needs to obtain data corresponding to the second data request information from the service server according to the second data request information.

In 204, the web server obtains the first data response packet after deletion of the format data from the cache server, and converts the first data response packet after deletion of the format data into a second data response packet.

Based on the key, the web server obtains corresponding data (i.e., value) from the cache server. The data (i.e., value) does not include the format data. In order to make sure that the data (i.e., value) is consistent with the data (i.e., value) desired by the client, after obtaining the first data response packet (i.e., after obtaining the value in the cache server), the web server converts the first data response packet into a second data response packet. Specifically, the web server adds the format data corresponding to the format parameter recorded in step 202 into the obtained first data response packet (i.e., the value).

As an example, if the URL included in the second data request information after deletion of the format parameter (or the first data request information after deletion of the format parameter), i.e., the key in the cache server, is:

http://api.lesports.com/sis-web/app/match/getMatchStatusByMatchIds?ids=1070, the first data response packet corresponding to the URL (i.e., the value) is: {callback: “ ”, +data”[. . . ], +msgs:[. . . ], result: 1, timeStamp: 20150921110502}, and the format parameter recorded by the web server in step 202 is: callback=abc, the web server dynamically adds the corresponding format data into the value according to the recorded format parameter: callback=abc. The value after addition of the format parameter is: abc({callback: “ ”, +data”[. . . ], +msgs:[. . . ],result: 1, timeStamp: 20150921110502}). It should be noted that the above are only exemplary examples, and embodiments of the present disclosure do not impose specific limitations on the contents of the first data request information, the second data request information, the first data response packet, the second data response packet and the format parameter.

In 205, the web server sends the second data response packet to the client.

Further, the determining of whether the first data response packet includes the format data corresponding to the format parameter by the web server can include: the web server parsing the first data response packet and traversing the parsed first data response packet; and determining whether the parsed first data response packet includes the format data corresponding to the format parameter. For example, if the parsed first data response packet includes: abc({callback: “ ”, +data”[. . . ], −msgs:[. . . ],result: 1, timeStamp: 20150921110502}), the web server traverses the first data response packet from the first character to the last character, and then determines that abc ( )is the format data of the first data response packet and deletes abc ( ); also, the web server stores the paired {callback: “ ”, +data”[. . . ], +msgs:[. . . ],result: 1, timeStamp: 20150921110502} and corresponding first data request information after deletion of the format parameter in the cache server.

The web server can communicate and interact with a plurality of cache servers which are distributed high speed cache servers and capable of responding to data request information sent from clients in time. By the contrary, in conventional technologies, keys and values are stored in a cache server according to similarity of the keys. If a web server receives a plurality of keys which are fairly similar to each other, the web server stores these keys and their values in one cache server, which results in overlarge load on the cache server and thereby lengthened latency for responding to clients by the web server.

Further, in order to reduce the load of the cache server and guarantee that the web server can respond to data request information timely, before storing of the first data request information after deletion of the format parameter and the first data response packet after deletion of the format data in the cache server, the web server encrypts the first data request information after deletion of the format parameter and the first data response packet after deletion of the format data, i.e., encrypts the key and the value corresponding to the key. The web server stores the encrypted key and value randomly in the cache server with the encrypted key and value as random character string. This can increase the dispersibility of the key and its corresponding value, and thus avoid overlarge load on the cache server caused by over-concentrated keys and corresponding values. The encryption methods of the key and corresponding value can include but not limited to: a Hash algorithm including Message-Digest Algorithm 5 (MD5). However, embodiments of the present disclosure are not limited to this.

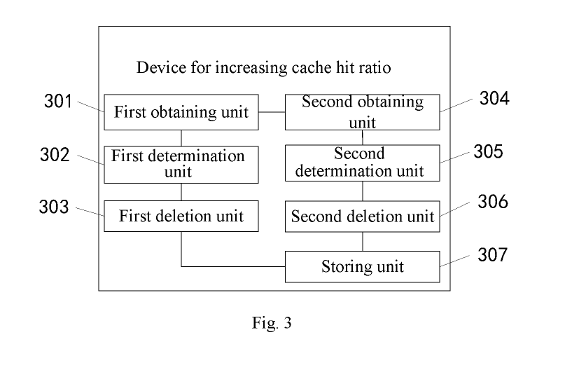

An embodiment of the present disclosure provides a device for increasing cache hit ratio to implement the method described in connection with FIG. 1. As shown in FIG. 3, the device includes a first obtaining unit 301, a first determination unit 302, a first deletion unit 303, a second obtaining unit 304, a second determination unit 305, a second deletion unit 306 and a storing unit 307.

The first obtaining unit 301 is configured to obtain first data request information which is date request information originally obtained by the device for increasing cache hit ratio. The device for increasing cache hit ratio receives the first data request information based on a service processing interface of the device itself. The service processing interface responds to the first data request information according to necessary parameters recorded in a configuration file for responding to the data request information. After obtaining the first data request information, the device for increasing cache hit ratio determines whether there is a format parameter in the first data request information. The format parameter is a unnecessary parameter for the device to respond to the first data request information. The format parameter generally includes a JSONP (JSON with Padding) format parameter used by the client when the device sends a first data response packet to the client.

The first determination unit 302 is configured to determine whether there is a format parameter in the first data request information obtained by the first obtaining unit 301.

The first deletion unit 303 is configured to, if the first determination unit 302 determines that there is the format parameter in the first data request information, delete the format parameter.

The second obtaining unit 304 is configured to obtain a first data response packet corresponding to the first data request information obtained by the first obtaining unit 301.

The second determination unit 305 is configured to determine whether the first data response packet obtained by the second obtaining unit 304 includes format data corresponding to the format parameter. The format data is configured to describe a format corresponding to data requested by the first data request information.

The second deletion unit 306 is configured to, if the second determination unit 305 determines that the first data response packet includes the format data corresponding to the format parameter, delete the format data.

The storing unit 307 is configured to store the first data request information in which the format parameter is deleted by the first deletion unit 303 and the first data response packet in which the format data is deleted by the second deletion unit 306 in a cache server. The first data request information after deletion of the format parameter corresponds to the first data response packet after deletion of the format data one to one.

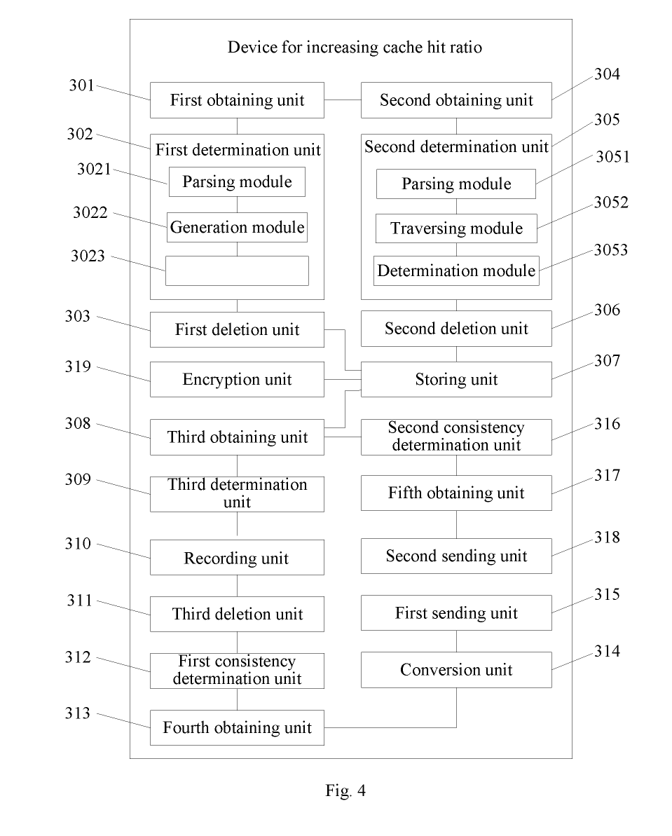

Further, as shown in FIG. 4, the device may further include a third obtaining unit 308, a third determination unit 309, a recording unit 310, a third deletion unit 311, a first consistency determination unit 312, a fourth obtaining unit 313, a conversion unit 314, a first sending unit 315.

The third obtaining unit 308 is configured to, after the storing unit 307 stores the first data request information after deletion of the format parameter and the first data response packet after deletion of the format data in the cache server, obtain second data request information.

The third determination unit 309 is configured to determine whether there is the format parameter in the second data request information obtained by the third obtaining unit 308.

The recording unit 310 is configured to, if the third determination unit 309 determines that there is the format parameter in the second data request information, record the format parameter. By doing this, when the device for increasing cache hit ratio, based on the second data request information after deletion of the format parameter (i.e., the key in the cache server), obtains corresponding data (i.e., value), the device dynamically adds the format corresponding to the format parameter for the data (i.e., value). This can increase the access efficiency of the device for increasing cache hit ratio and guarantee the accuracy in data obtaining by the client.

The third deletion unit 311 is configured to, after the recording unit 310 records the format parameter, delete the format parameter.

The first consistency determination unit 312 is configured to determine whether the first data request information after deletion of the format parameter is consistent with the second data request information in which the format parameter is deleted by the third deletion unit 311.

The fourth obtaining unit 313 is configured to, if the first consistency determination unit 312 determines that the first data request information after deletion of the format parameter is consistent with the second data request information in which the format parameter is consistent by the third deletion unit 311, obtain the first data response packet after deletion of the format data from the cache server.

The conversion unit 314 is configured to convert the first data response packet after deletion of the format data obtained by the fourth obtaining unit 313 into a second data response packet which includes format data corresponding to the recorded format parameter which is dynamically added to the first data response packet after deletion of the format data.

The first sending unit 315 is configured to send the second data response packet converted by the conversion unit 314 to a client.

Further, as shown in FIG. 4, the device may further include a second consistency determination unit 316, a fifth obtaining unit 317, and a second sending unit 318.

The second consistency determination unit 316 is configured to, if it is determined that there is not the format parameter in the second data request information obtained by the third obtaining unit 308, determine whether the first data request information after deletion of the format parameter is consistent with the second data request information.

The fifth obtaining unit 317 is configured to, if the second consistency determination unit 316 determines that the first data request information after deletion of the format parameter is consistent with the second data request information, obtain the first data response packet after deletion of the format data from the cache server.

The second sending unit 318 is configured to send the first data response packet obtained by the fifth obtaining unit 317 to the client.

Further, as shown in FIG. 4, the first determination unit 302 may include a parsing module 3021, an obtaining module 3022 and a determination module 3023.

The parsing module 3021 is configured to parse the first data request information.

The obtaining module 3022 is configured to, after the parsing module 3021 parses the first data request information, obtain a Uniform Resource Locator (URL) which is included in the first data request information.

The determination module 3023 is configured to determine whether there is the format parameter in the URL obtained by the obtaining module 3022.

Further, as shown in FIG. 4, the second determination unit 305 may include a parsing module 3051, a traversing module 3052 and a determination module 3053.

The parsing module 3051 is configured to parsing the first data response packet

The traversing module 3052 is configured to, after the parsing module 3051 parses the first data response packet, traverse the parsed first data response packet.

The determination module 3053 is configured to determine whether the parsed first data response packet includes the format data corresponding to the format parameter.

Further, as shown in FIG. 4, the device may further include an encryption unit 319.

The encryption unit 319 is configured to, before the storing unit 307 stores the first data request information after deletion of the format parameter and the first data response packet after deletion of the format data in the cache server, encrypt the first data request information after deletion of the format parameter and the first data response packet after deletion of the format data.

The storing unit 307 is configured to store the first data request information after deletion of the format parameter and the first data response packet after deletion of the format data encrypted by the encryption unit 319 in the cache server.

In the devices for increasing cache hit ratio provided by embodiments of the present disclosure, firstly, a web server obtains first data request information, and determines whether there is a format parameter in the first data request information; the first data request information is data request information originally obtained by the web server; if there is the format parameter in the first data request information, the web server deletes the format parameter; then, the web server obtains a first data response packet corresponding to the first data request information, and determines whether the first data response packet includes format data corresponding to the format parameter; if the first data response packet includes format data corresponding to the format parameter, the web server deletes the format data from the first data response packet; finally, the web server stores the first data request information after deletion of the format parameter and the first data response packet after deletion of the format data in a cache server. As compared with prior technologies, the web server in embodiments of the present disclosure deletes the format parameter from the received data request information, and this can increase the possibility that the data request information matches a key in the cache server. Further, the web server deletes the format data from the obtained first data response packet to make the same data (value) have the same type. Thus, the cache hit ratio is increased, and latency for responding to the data requests from clients is shortened.

It should be noted that the functions of respective units or modules in the above device for increasing cache hit ratio according to embodiments of the present disclosure can be realized by hardware processors.

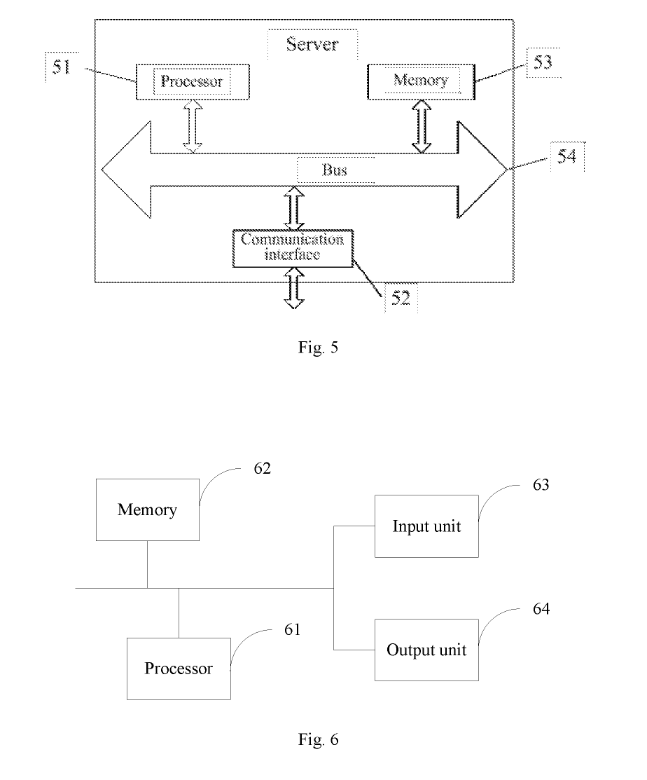

As an example, FIG. 5 is a block diagram showing a physical structure of a web server in accordance with an embodiment of the present disclosure. The server can include a processor 51, a communication interface 52, a memory 53 and a bus 54. The processor 51, the communication interface 52 and the memory 53 communicate with each other via the bus 54. The communication interface 52 may be used for information transmission between the server and a client. The processor 51 calls logic instructions in the memory 53 to perform the following method: obtaining first data request information, and determining whether there is a format parameter in the first data request information; if determining that there is the format parameter in the first data request information, deleting the format parameter; obtaining a first data response packet corresponding to the first data request information, and determining whether the first data response packet includes format data corresponding to the format parameter, wherein the format data is configured to describe a format corresponding to data requested by the first data request information; if determining that the first data response packet includes the format data corresponding to the format parameter, deleting the format data; and storing the first data request information after deletion of the format parameter and the first data response packet after deletion of the format data in a cache server, wherein the first data request information after deletion of the format parameter corresponds to the first data response packet after deletion of the format data one to one.

In addition, the logic instructions in the memory 53 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements. Those skilled in this art may understand and practice the technical solutions of the present disclosure without creative work.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for increasing cache hit ratio, implemented by a server, comprising:
obtaining first data request information, and determining whether there is a format parameter in the first data request information, wherein the first data request information is data request information originally obtained by the server;
if determining that there is the format parameter in the first data request information, deleting the format parameter;
obtaining a first data response packet corresponding to the first data request information, and determining whether the first data response packet comprises format data corresponding to the format parameter, wherein the format data is configured to describe a format corresponding to data requested by the first data request information;
if determining that the first data response packet comprises the format data corresponding to the format parameter, deleting the format data; and
storing the first data request information after deletion of the format parameter and the first data response packet after deletion of the format data in a cache server, wherein the first data request information after deletion of the format parameter corresponds to the first data response packet after deletion of the format data one to one.

2. The method according to claim 1, further comprises:
after storing of the first data request information after deletion of the format parameter and the first data response packet after deletion of the format data in the cache server, obtaining second data request information, and determining whether there is the format parameter in the second data request information;
if determining that there is the format parameter in the second data request information, recording the format parameter, and deleting the format parameter;
determining whether the first data request information after deletion of the format parameter is consistent with the second data request information after deletion of the format parameter;
if the first data request information after deletion of the format parameter is consistent with the second data request information after deletion of the format parameter, obtaining the first data response packet after deletion of the format data from the cache server, and converting the first data response packet after deletion of the format data into a second data response packet which comprises format data corresponding to the recorded format parameter which is dynamically added to the first data response packet after deletion of the format data; and
sending the second data response packet to a client.

3. The method according to claim 2, further comprising:
if determining that there is not the format parameter in the second data request information, determining whether the first data request information after deletion of the format parameter is consistent with the second data request information;
if the first data request information after deletion of the format parameter is consistent with the second data request information, obtaining the first data response packet after deletion of the format data from the cache server, and sending the first data response packet after deletion of the format data to the client.

4. The method according to claim 1, wherein the determining of whether there is the format parameter in the first data request information comprises:
parsing the first data request information and obtaining a Uniform Resource Locator (URL) which is comprised in the first data request information; and
determining whether there is the format parameter in the URL.

5. The method according to claim 4, wherein the determining of whether the first data response packet comprises the format data corresponding to the format parameter comprises:
parsing the first data response packet and traversing the parsed first data response packet; and
determining whether the parsed first data response packet comprises the format data corresponding to the format parameter.

6. The method according to claim 5, wherein before the storing of the first data request information after deletion of the format parameter and the first data response packet after deletion of the format data in the cache server, the method further comprises:
encrypting the first data request information after deletion of the format parameter and the first data response packet after deletion of the format data;
wherein the storing of the first data request information after deletion of the format parameter and the first data response packet after deletion of the format data in the cache server comprises:
storing the encrypted first data request information after deletion of the format parameter and the encrypted first data response packet after deletion of the format data in the cache server.

7. An electronic device, comprising:
at least one processor; and
a memory communicably connected with the at least one processor for storing instructions executable by the at least one processor, wherein execution of the instructions by the at least one processor causes the at least one processor to:
obtain first data request information, and determine whether there is a format parameter in the first data request information, wherein the first data request information is data request information originally obtained by the electronic device;
if determining that there is the format parameter in the first data request information, delete the format parameter;
obtain a first data response packet corresponding to the first data request information, and determine whether the first data response packet comprises format data corresponding to the format parameter, wherein the format data is configured to describe a format corresponding to data requested by the first data request information;
if determining that the first data response packet comprises the format data corresponding to the format parameter, delete the format data; and
store the first data request information after deletion of the format parameter and the first data response packet after deletion of the format data in a cache server, wherein the first data request information after deletion of the format parameter corresponds to the first data response packet after deletion of the format data one to one.

8. The electronic device according to claim 7, wherein the instructions are executed to cause the at least one processor to:
after storing of the first data request information after deletion of the format parameter and the first data response packet after deletion of the format data in the cache server, obtain second data request information, and determine whether there is the format parameter in the second data request information;
if determining that there is the format parameter in the second data request information, record the format parameter, and delete the format parameter;
determine whether the first data request information after deletion of the format parameter is consistent with the second data request information after deletion of the format parameter;
if the first data request information after deletion of the format parameter is consistent with the second data request information after deletion of the format parameter, obtain the first data response packet after deletion of the format data from the cache server, and convert the first data response packet after deletion of the format data into a second data response packet which comprises format data corresponding to the recorded format parameter which is dynamically added to the first data response packet after deletion of the format data; and
send the second data response packet to a client.

9. The electronic device according to claim 8, wherein the instructions are executed to cause the at least one processor to:
if determining that there is not the format parameter in the second data request information, determine whether the first data request information after deletion of the format parameter is consistent with the second data request information;
if the first data request information after deletion of the format parameter is consistent with the second data request information, obtain the first data response packet after deletion of the format data from the cache server, and send the first data response packet after deletion of the format data to the client.

10. The electronic device according to claim 7, wherein the determining of whether there is the format parameter in the first data request information comprises:
parsing the first data request information and obtaining a Uniform Resource Locator (URL) which is comprised in the first data request information; and
determining whether there is the format parameter in the URL.

11. The electronic device according to claim 10, wherein the determining of whether the first data response packet comprises the format data corresponding to the format parameter comprises:
parsing the first data response packet and traversing the parsed first data response packet; and
determining whether the parsed first data response packet comprises the format data corresponding to the format parameter.

12. The electronic device according to claim 11, wherein before the storing of the first data request information after deletion of the format parameter and the first data response packet after deletion of the format data in the cache server, wherein the instructions are executed to cause the at least one processor to:
encrypt the first data request information after deletion of the format parameter and the first data response packet after deletion of the format data;
wherein the storing of the first data request information after deletion of the format parameter and the first data response packet after deletion of the format data in the cache server comprises:
storing the encrypted first data request information after deletion of the format parameter and the encrypted first data response packet after deletion of the format data in the cache server.

13. A non-transitory computer-readable storage medium storing executable instructions that, when executed by an electronic device, cause the electronic device to:
obtain first data request information, and determine whether there is a format parameter in the first data request information, wherein the first data request information is data request information originally obtained by the electronic device;
if determining that there is the format parameter in the first data request information, delete the format parameter;
obtain a first data response packet corresponding to the first data request information, and determine whether the first data response packet comprises format data corresponding to the format parameter, wherein the format data is configured to describe a format corresponding to data requested by the first data request information;
if determining that the first data response packet comprises the format data corresponding to the format parameter, delete the format data; and
store the first data request information after deletion of the format parameter and the first data response packet after deletion of the format data in a cache server, wherein the first data request information after deletion of the format parameter corresponds to the first data response packet after deletion of the format data one to one.

14. The non-transitory computer-readable storage medium according to claim 13, wherein the executable instructions are executed to cause the electronic device to:
after storing of the first data request information after deletion of the format parameter and the first data response packet after deletion of the format data in the cache server, obtain second data request information, and determine whether there is the format parameter in the second data request information;
if determining that there is the format parameter in the second data request information, record the format parameter, and delete the format parameter;
determine whether the first data request information after deletion of the format parameter is consistent with the second data request information after deletion of the format parameter;
if the first data request information after deletion of the format parameter is consistent with the second data request information after deletion of the format parameter, obtain the first data response packet after deletion of the format data from the cache server, and convert the first data response packet after deletion of the format data into a second data response packet which comprises format data corresponding to the recorded format parameter which is dynamically added to the first data response packet after deletion of the format data; and
send the second data response packet to a client.

15. The non-transitory computer-readable storage medium according to claim 14, wherein the executable instructions are executed to cause the electronic device to:
if determining that there is not the format parameter in the second data request information, determine whether the first data request information after deletion of the format parameter is consistent with the second data request information;
if the first data request information after deletion of the format parameter is consistent with the second data request information, obtain the first data response packet after deletion of the format data from the cache server, and send the first data response packet after deletion of the format data to the client.

16. The non-transitory computer-readable storage medium according to claim 13, wherein the determining of whether there is the format parameter in the first data request information comprises:
parsing the first data request information and obtaining a Uniform Resource Locator (URL) which is comprised in the first data request information; and
determining whether there is the format parameter in the URL.

17. The non-transitory computer-readable storage medium according to claim 16, wherein the determining of whether the first data response packet comprises the format data corresponding to the format parameter comprises:
parsing the first data response packet and traversing the parsed first data response packet; and
determining whether the parsed first data response packet comprises the format data corresponding to the format parameter.

18. The non-transitory computer-readable storage medium according to claim 17, wherein before the storing of the first data request information after deletion of the format parameter and the first data response packet after deletion of the format data in the cache server, wherein the executable instructions are executed to cause the electronic device to:
encrypt the first data request information after deletion of the format parameter and the first data response packet after deletion of the format data;
wherein the storing of the first data request information after deletion of the format parameter and the first data response packet after deletion of the format data in the cache server comprises:
storing the encrypted first data request information after deletion of the format parameter and the encrypted first data response packet after deletion of the format data in the cache server.
